(19) United States
(12) Patent Application Publication
(10) Pub. No.: US 2021/0108078 A1
(43) Pub. Date: Apr. 15, 2021

(54) POLYPHENYLENE SULFIDE RESIN COMPOSITION FOR EXTRUSION MOLDING

(71) Applicant: Toray Resin Company, Shelbyville, IN (US)

(72) Inventors: So Wakao, Shelbyville, IN (US); Kazuki Akiba, Shelbyville, IN (US)

(73) Assignee: Toray Resin Company, Shelbyville, IN (US)

(21) Appl. No.: 16/653,426

(22) Filed: Oct. 15, 2019

(51) Int. Cl. C08L 81/04; B29C 48/00

(52) U.S. Cl. CPC C08L 81/04; B29C 48/022; B29C 48/09; C08L 2205/025; C08L 2205/06; C08L 2205/035

(57) ABSTRACT

Provided is a polyphenylene sulfide resin composition with components (A)-(E) for extrusion molding. The resin composition is excellent in processability at the time of extrusion molding, and furthermore, an extruded product with a low appearance gas and a good appearance can be obtained. Therefore, it is useful for electronic equipment, automobile parts, structural parts, machine parts, oil drilling/transport parts, etc.

### FIELD OF THE INVENTION

The present invention relates to a polyphenylene sulfide (PPS) resin composition for extrusion molding. The present invention is excellent in processability at the time of extrusion molding, and furthermore, an extruded product with a low emission gas and a good appearance can be obtained. The obtained product is useful for electronic equipment, automobile parts, structural parts, machine parts, and oil drilling and transport parts, etc. The present invention relates to a polyphenylene sulfide resin composition and an extrusion molded product using the same.

### TECHNICAL BACKGROUND

Polyphenylene sulfide resin (hereinafter sometimes abbreviated as PPS resin) has excellent properties as engineering plastics such as excellent heat resistance, chemical resistance, electrical insulation, and heat and humidity resistance. Thus, it is used in a wide range of fields, especially in the electronic equipment, automotive, oil, and gas fields.

In particular, as a piping member (e.g., tube; pipe) for automobile applications, in recent years, a piping member using PPS resin that is excellent in heat resistance and chemical resistance other than metals has been studied in view of weight reduction for the purpose of improving fuel efficiency.

Also, in oil and gas applications, piping members using PPS resin that are excellent in strength, heat resistance, and chemical resistance are used because they are exposed to high temperature gas and oil during excavation. On the other hand, since PPS resin has low extrudability due to its low toughness and poor feeding stability during processing, thus low productivity is one of the challenges.

For example, Patent Document 1 proposes a resin composition containing a graft copolymer in a PPS resin, but does not describe any extrudability.

As another example, Patent Document 2 proposes a method for producing a corrugated tube using a PPS resin, but it does not describe any extrudability.

### PRIOR ART DOCUMENT

[Patent Document 1] U.S. Pat. No.; 5,668,214

[Patent Document 2] U.S. Pat. No.; 5,792,532

### DISCLOSURE OF THE INVENTION

### Problems to be Solved by the Invention

An object of the present invention is to obtain a polyphenylene resin composition excellent in extrusion processability, and useful for applications requiring heat resistance and chemical resistance such as automobiles, oils, and gas applications.

### Means for Solving the Problem

That is, the present invention provides the following:

(1) A polyphenylene sulfide resin composition for extrusion molding comprising:
a mixture of:
(A) a polyphenylene sulfide resin having a melt flow rate of from 50 g/10 min to 400 g/10 min measured at 316° C. and 5 kg;
(B) a glycidyl group-containing copolymer comprising α-olefin and α, β-unsaturated glycidyl ester as a copolymerization component;
(C) a copolymerization component comprising ethylene and an α-olefin having 3 to 20 carbon atoms;
(D) a glass fiber; and
(E) polyethylene,
where (A) is at least 100 parts by weight for every 5 to 15 parts by weight of (B), 0 to 20 parts by weight of (C), 10 to 50 parts by weight of (D), and 1.5 to 4 parts by weight of (E).

(2) The polyphenylene sulfide resin composition for extrusion molding described in (1), but wherein:
(A) comprises (A-1) and (A-2), and a weight ratio of (A-1) and (A-2) is from 3:7 to 7:3, where
(A-1) is a polyphenylene sulfide resin having a melt flow rate of 50 g/10 min to 200 g/10 min measured at 316 ° C. and 5 kg, and (A-2) is a polyphenylene sulfide resin having a melt flow rate of 200 g/10 min to 400 g / 10 min measured at 316 ° C. and 5 kg.

(3) The polyphenylene sulfide resin composition for extrusion molding described in (1) wherein:
(E) comprises polyethylene having a melt flow rate of 0.01-0.1 g/10 min measured at 190° C. and 2.16 kg.

(4) An extruded product comprising the polyphenylene sulfide resin composition for extrusion molding as described in (1) above.

(5) The extruded product comprising the polyphenylene sulfide resin composition after extrusion molding as described in (4) above, wherein the extruded product has an average outer diameter of 50 mm or more.

### Effects of the Invention

The present invention provides a polyphenylene resin composition and an extrusion molded product comprising the composition thereof which have excellent in extrudability useful for applications requiring heat resistance and chemical resistance, such as electronic equipment, automobiles, oils, and gas applications.

### DETAILED DESCRIPTION OF THE INVENTION

### Resin Composition

The polyphenylene sulfide resin composition of the present invention is a mixture comprising the following compositions:

at least, 100 parts by weight of (A), adding 5 to 15 parts by weight of (B), 0 to 20 parts by weight of (C), 10 to 50 parts by weight of (D) and 1.5 to 4 parts by weight of (E).

(A) polyphenylene sulfide resin having a melt flow rate measured at 316° C. and 5 kg, being from 50 g/10 min to 400 g/10 min,

(B) glycidyl group-containing copolymer comprising α-olefin and α, β-unsaturated glycidyl ester as a copolymerization component,

(C) copolymerization component comprising ethylene and an α-olefin having 3 to 20 carbon atoms;

(D) glass fiber; and

(E) polyethylene.

(1) Polyphenylene sulfide

(A) PPS resin used in the present invention is a polymer having a repeating unit represented by the following structural formula (I):

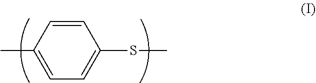

From the viewpoint of heat resistance, a polymer containing 70 mol % or more, more preferably 90 mol % or more of a polymer containing a repeating unit represented by the above structural formula (I) is preferred. Moreover, less than 30 mol % of the repeating units of the PPS resin may be composed of repeating units having the following structures:

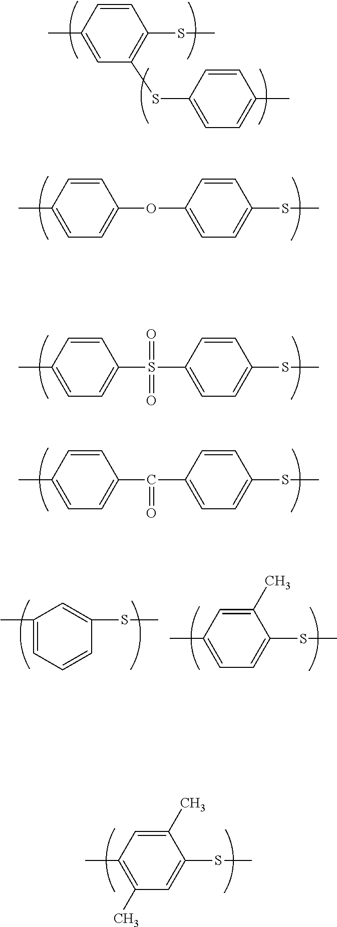

Since in a PPS resin, the smaller the amount of chloroform that is extracted, the smaller the oligomer component, which lowers the chlorine content. Therefore, the amount of chloroform extracted from the (A) PPS resin used in the present invention is preferably 0.5% by weight or less for obtaining a low-salt resin composition, and further preferably 0.4% by weight or less.

When the amount of chloroform extracted from the PPS resin exceeds 0.5% by weight, the amount of chloroform extracted from the resin composition using the PPS resin is undesirably large. In the present invention, as a method for reducing the amount of chloroform extracted, in which a polymerization step and a post-treatment step are combined, is preferably used as described herein later. The chloroform extraction of (A) PPS resin in the present invention is performed with a Soxhlet extractor, by freeze-pulverizing the PPS resin, extracting the chloroform for 5 hours with 32 mesh pass, 2.0 gram of mesh particles of 42 mesh-on, and 200 ml of chloroform, then drying the extract at 50° C. The chloroform extraction amount is represented in percentage of the weight of the residue of the extract divided by the amount of the PPS resin sample used.

The melt viscosity of the (A) PPS resin used in the present invention is preferably in the range of 5 to 50 Pa·s (310° C., shear rate 1,216/s) from the viewpoint of obtaining a resin composition having excellent melt fluidity, and the range of 10 to 45 Pa·s is more preferable, and the range of 10 to 40 Pa·s is further more preferable. Two or more polyphenylene sulfide resins having different melt viscosities may be used in combination. The melt viscosity of the (A) PPS resin in the present invention is a value measured using a CAPILOGRAPH® manufactured by Toyo Seiki Co. under conditions of 310° C. and a shear rate of 1,216/s.

A manufacturing method of (A) PPS resin used for this invention is demonstrated below, if the PPS resin which has the structure and characteristic described above is obtained, it will not be limited to the following method. However, a method in which dichlorobenzene and a sulfur source are the main monomers (90 mol % or more) and polymerization is carried out in the presence of an aprotic polar solvent is most preferable in terms of production stability.

Next, the contents of the polyhalogenated aromatic compound, sulfidizing agent, polymerization solvent, molecular weight regulator, polymerization aid, and polymerization stabilizer used in the production will be described.

### Polyhalogenated Aromatic Compounds

The polyhalogenated aromatic compound (PHA) used in the present invention refers to a compound having two or more halogen atoms in one molecule. Specific examples include polyhalogenated aromatics such as p-dichlorobenzene, m-dichlorobenzene, o-dichlorobenzene, 1,3,5-trichlorobenzene, 1,2,4-trichlorobenzene, 1,2,4,5-tetrachlorobenzene, hexachlorobenzene, 2,5-dichlorotoluene, 2,5-dichloro-p-xylene, 1,4-dibromobenzene, 1,4-diiodobenzene, and 1-methoxy-2,5-dichlorobenzene. Preferably, polychlorobenzene such as p-dichlorobenzene, m-dichlorobenzene, o-dichlorobenzene, 1,3,5-trichlorobenzene, 1,2,4-trichlorobenzene, and 1,2,4,5-tetrachlorobenzene is used. Among them, p-dichlorobenzene is particularly preferably used. It is also possible to combine two or more different polyhalogenated aromatic compounds into a copolymer, but a p-dihalogenated aromatic compound represented by p-dichlorobenzene is preferably used as a main component.

The polyhalogenated aromatic compound is used in an amount of 0.8 to 1.023 mol, preferably 0.8 to 1.020 mol, per 1 mol of the sulfidizing agent from the viewpoint of obtaining a PPS resin having a viscosity suitable for processing and low oligomer elution. Further, in the sense of achieving both a degree of polymerization useful for the present invention and low oligomer properties, a range of 0.9 to 1.015 mol is useful. In the case of the above range, a PPS resin in which the above-described chloroform extraction amount is in a preferable range can be obtained.

### Sulfidizing Agent

A sulfidizing agent used in the present invention include alkali metal sulfides, alkali metal hydrosulfides, and hydrogen sulfide, for example.

Specific examples of the alkali metal sulfide include, for example, lithium sulfide, sodium sulfide, potassium sulfide, rubidium sulfide, cesium sulfide, and a mixture of two or more of these. Sodium sulfide is preferably used. These alkali metal sulfides can be used as hydrates or aqueous mixtures, or in the form of anhydrides.

Specific examples of the alkali metal hydrosulfide include, for example, sodium hydrosulfide, potassium hydrosulfide, lithium hydrosulfide, rubidium hydrosulfide, cesium hydrosulfide, and a mixture of two or more of these. Among these, sodium hydrosulfide is preferably used. These alkali metal hydrosulfides can be used as hydrates, aqueous mixtures, or in the form of anhydrides.

In addition, an alkali metal sulfide prepared in situ in a reaction system from an alkali metal hydrosulfide and an alkali metal hydroxide can also be used. Moreover, an alkali metal sulfide can be prepared from an alkali metal hydrosulfide and an alkali metal hydroxide, and transferred to a polymerization tank for use.

Alternatively, an alkali metal sulfide prepared in situ in a reaction system from hydrogen sulfide and an alkali metal hydroxide, such as lithium hydroxide or sodium hydroxide, can also be used. Moreover, an alkali metal sulfide can be prepared from hydrogen sulfide and an alkali metal hydroxide, such as lithium hydroxide or sodium hydroxide, and transferred to a polymerization tank for use.

In the present invention, the amount of the sulfidizing agent charged means the remaining amount obtained by subtracting the loss from the actual charged amount when a partial loss of the sulfidizing agent occurs before the start of the polymerization reaction due to the dehydration operation or the like.

An alkali metal hydroxide and/or an alkaline earth metal hydroxide can be used in combination with the sulfidizing agent. Specific examples of the alkali metal hydroxide include, for example, sodium hydroxide, potassium hydroxide, lithium hydroxide, rubidium hydroxide, cesium hydroxide, and a mixture of two or more thereof. Specific examples of the alkaline earth metal hydroxide include, for example, calcium hydroxide, strontium hydroxide, and barium hydroxide. Among these sodium hydroxide is preferably used.

When an alkali metal hydrosulfide is used as the sulfidizing agent, it is particularly preferable to use an alkali metal hydroxide at the same time, but the amount used is 0.90 to 1.10 mol, preferably 0.90 to 1.05 mol, and more preferably 0.95 to 1.02 mol, per 1 mol of alkali metal hydrosulfide, can be exemplified.

### Polymerization Solvent

In the present invention, an organic polar solvent is used as a polymerization solvent. Specific examples include an aprotic organic solvent represented by N-alkylpyrrolidones such as N-methyl-2-pyrrolidone and N-ethyl-2-pyrrolidone, caprolactams such as N-methyl-ε-caprolactam, caprolactam, 1,3-dimethyl-2-imidazolide, N,N-dimethylacetamide, N,N-dimethylformamide, hexamethylphosphoric triamide, dimethyl sulfone, tetramethylene sulfoxide, and the like, and mixtures thereof.

These are preferably used because of their high reaction stability. Among these, N-methyl-2-pyrrolidone (hereinafter sometimes abbreviated as NMP) is particularly preferred. The amount of the organic polar solvent used is selected in the range of 2.0 to 10 mol, preferably 2.25 to 6.0 mol, more preferably 2.5 to 5.5 mol, per 1 mol of the sulfidizing agent.

### Molecular Weight Regulator

In the present invention, a monohalogenated compound (which may not necessarily be an aromatic compound) may be used in combination with the polyhalogenated aromatic compound described herein in order to form a terminal end of the PPS resin to be formed or to adjust a polymerization reaction or a molecular weight of the PPS resin.

Examples of the monohalogenated compound as the molecular weight regulator (or to adjust the polymerization reaction) include monohalogenated benzene, monohalogenated naphthalene, monohalogenated anthracene, monohalogenated compound containing 2 or more benzene rings, monohalogenated heterocyclic compound, and the like. Among them, monohalogenated benzene is preferable from the viewpoint of economy. Specifically, 2-chlorobenzoic acid, 3-chlorobenzoic acid, 4-chlorobenzoic acid, sodium 4-chlorophthalate, 2-amino-4-chlorobenzoic acid, 4-chloro-3-nitrobenzoic acid, and 4′-chlorobenzophenone-2-carboxylic acid can be used.

In view of reactivity during polymerization and versatility, 3-chlorobenzoic acid, 4-chlorobenzoic acid, and sodium 4-chlorophthalate are preferred. In addition, the monohalogenated compound can also be used for the purpose of adjusting the molecular weight of the PPS resin or for reducing the chlorine content of the PPS resin.

When the carboxyl group-containing monohalogenated compound is used, it contributes not only to an increase in the carboxyl group content, but also to a reduction in the chlorine content of the PPS resin.

### Polymerization Aid

In the present invention, it is also a preferred embodiment to use a polymerization aid for adjusting the degree of polymerization. Here, the polymerization aid means a substance having an action of increasing the viscosity of the obtained PPS resin. Specific examples of such polymerization aids include, for example, alkali metal carboxylate, organic carboxylates, water, alkali metal chlorides, organic sulfonates, alkali metal sulfates, alkaline earth metal oxides, alkali metal phosphates, alkaline earth metal phosphates, and the like. These may be used alone or in combination of two or more. Among these, organic carboxylates, water, and alkali metal chlorides are preferable, and sodium and lithium carboxylates and/or water are particularly preferably used.

The alkali metal carboxylate described above is a compound represented by a general formula R(COOM) n, wherein R is an alkyl group, cycloalkyl group, aryl group, alkylaryl group or arylalkyl group having 1 to 20 carbon atoms; M is an alkali metal selected from lithium, sodium, potassium, rubidium and cesium; and n is an integer of 1 to 3. Alkali metal carboxylates can also be used as hydrates, anhydrides, or aqueous solutions. Specific examples of the alkali metal carboxylate include, for example, lithium acetate, sodium acetate, potassium acetate, sodium propionate, lithium valerate, sodium benzoate, sodium phenylacetate, potassium p-toluate, and mixtures thereof.

The alkali metal carboxylate can be obtained by reaction of approximately equal chemical equivalents of an organic acid and one or more compounds selected from the group consisting of alkali metal hydroxides, alkali metal carbonates, and alkali metal bicarbonates. Among the alkali metal carboxylates described herein, lithium salts are highly soluble in the reaction system and have a large auxiliary effect, but are expensive, and potassium, rubidium and cesium salts are insufficiently soluble in the reaction system. Therefore, sodium acetate, which is inexpensive and has an appropriate solubility in the polymerization system, is preferably used.

When using these alkali metal carboxylates as polymerization aids, the amount used is usually from 0.01 to 2 mol per 1 mol of the charged sulfidizing agent from the viewpoint of obtaining a PPS resin having a viscosity suitable for processing and oligomer low elution. In the range of 0.010 to 0.088 mol is preferable from the viewpoint of achieving both the degree of polymerization useful for the present invention and low oligomer property. In the case the above range is used, a PPS resin having the above-described melt viscosity in a preferable range can be obtained.

In addition, when water is used as a polymerization aid, the addition amount is usually in the range of 0.3 mol to 15 mol per 1 mol of the charged sulfidizing agent, and in the sense of obtaining a higher degree of polymerization, 0.6 to 10 mol is preferable, and the range of 1 to 5 mol is more preferable. Of course, two or more kinds of these polymerization aids can be used in combination. For example, when an alkali metal carboxylate and water are used in combination, a higher molecular weight can be obtained in a smaller amount than when each is used alone.

There is no particular designation as to the timing of addition of these polymerization aids, which may be added at any time during a pre-process, at a polymerization start, or during a polymerization which will be described later, or may be added in multiple times. When using an alkali metal carboxylate as a polymerization aid, it is more preferable to add it at a start of the pre-process or at a start of the polymerization from the viewpoint of easy addition. When water is used as a polymerization aid, it is effective to add the water during the polymerization after the polyhalogenated aromatic compound is charged.

### Polymerization Stabilizer

In the present invention, a polymerization stabilizer may be used to stabilize the polymerization reaction system and prevent side reactions. The polymerization stabilizer contributes to stabilization of the polymerization reaction system and suppresses undesirable side reactions. One measure of the side reaction is the generation of thiophenol, and the addition of a polymerization stabilizer can suppress the generation of thiophenol. Specific examples of the polymerization stabilizer include compounds such as alkali metal hydroxides, alkali metal carbonates, alkaline earth metal hydroxides, and alkaline earth metal carbonates. Among these, alkali metal hydroxides, such as sodium hydroxide, potassium hydroxide, and lithium hydroxide, are preferred.

Since the alkali metal carboxylate described herein also acts as a polymerization stabilizer, it may be one of the polymerization stabilizers used in the present invention. In addition, when an alkali metal hydrosulfide is used as a sulfidizing agent as described herein, that it is particularly preferable to use an alkali metal hydroxide at the same time. Alkali metal hydroxides in excess relative to the sulfidizing agent can also serve as a polymerization stabilizer.

These polymerization stabilizers can be used alone or in combination of two or more. The polymerization stabilizer is preferably used with an amount of usually 0.02 to 0.2 mol, preferably 0.03 to 0.1 mol, and more preferably 0.04 to 0.09 mol, in proportion relative to 1 mol of the charged sulfidizing agent. If this proportion is too small, the stabilizing effect is insufficient conversely, if the proportion is too large, it is economically disadvantageous or the polymer yield tends to decrease.

There is no particular designation as to the timing of addition of these polymerization stabilizers, which may be added at any time during a pre-process, at a polymerization start, or during a polymerization, or may be added in multiple times. It is more preferable to add at the start of the pre-process or at the start of polymerization from the viewpoint of easy addition.

Next, the production method of the (A) PPS resin used in the present invention will be specifically described in the order of the pre-process, polymerization reaction process, recovery process, and post-treatment process.

### Pre-Process

In the method for producing the (A) PPS resin used in the present invention, the sulfidizing agent is usually used in the form of a hydrate. It is preferable to raise the temperature of the mixture including an organic polar solvent and the sulfidizing agent and to remove an excessive amount of water out of the system before adding the polyhalogenated aromatic compound.

As described above, a sulfidizing agent prepared from an alkali metal hydrosulfide and an alkali metal hydroxide in situ in the reaction system, or in a tank different from the polymerization tank is also used as the sulfidizing agent.

Although there is no particular limitation on this method, desirably an alkali metal hydrosulfide and an alkali metal hydroxide are added to the organic polar solvent in an inert gas atmosphere at a temperature ranging from room temperature to 150° C., preferably from room temperature to 100° C., then, the water is distilled away by raising the temperature to at least 150° C. or more, preferably 180 to 260° C. under normal or reduced pressure. Polymerization aids can be added at this stage. In addition, toluene, etc., can be added for the reaction to accelerate the distillation of the water.

The amount of water in the polymerization system in the polymerization reaction is preferably 0.3 to 10.0 moles per 1 mole of the sulfidizing agent charged. Here, the amount of water in the polymerization system is an amount obtained by subtracting the amount of water removed out of the polymerization system from the amount of water charged in the polymerization system. In addition, the water to be charged may be in any form such as water, an aqueous solution, and crystal water.

### Polymerization Reaction Step

In the present invention, a PPS resin is produced by reacting a sulfidizing agent and a polyhalogenated aromatic compound in an organic polar solvent within a temperature range of 200° C. or higher and lower than 290° C. When starting the polymerization reaction step, the organic polar solvent, the sulfidizing agent and the polyhalogenated aromatic compound are mixed desirably in an inert gas atmosphere at a temperature between room temperature to 240° C., preferably in the range between 100 to 230° C. A polymerization aid may be added at this stage. The order in which these raw materials are charged may be random or may be simultaneous.

Such a mixture is usually heated to a temperature in the range of 200° C. to 290° C. Although there are no particular limitations on the rate of temperature increase, a rate of 0.01 to 5° C./min is usually selected, and a range of 0.1 to 3 ° C./min is more preferable. In general, the temperature is finally raised to a temperature between 250 and 290° C., and the reaction is usually carried out at that temperature for 0.25 to 50 hours, preferably 0.5 to 20 hours. In the stage before reaching the final temperature, for example, a method of reacting at a temperature between 200° C. and 260° C. for a certain amount of time and then raising the temperature to between 270° C. and 290° C., is effective in obtaining a higher degree of polymerization. In this case, the reaction time at the temperature between 200° C. and 260° C. is usually selected in the range of 0.25 to 20 hours, preferably in the range of 0.25 to 10 hours. Other times, such as 0.5, 1, 5, etc. hours are contemplated.

In order to obtain a polymer having a higher degree of polymerization, it may be effective to perform polymerization in multiple stages. When the polymerization is performed in a plurality of stages, it is effective to advance to the next stage when the conversion of the polyhalogenated aromatic compound in the system at 245° C. reaches 40 mol % or more, preferably 50mo1% or more, and more preferably 60 mol %.

Further, the conversion rate of the polyhalogenated aromatic compound is a value calculated by the following formula. The residual amount of PHA can usually be determined by gas chromatography.

(a) When polyhalogenated aromatic compound is excessively added at a molar ratio to the alkali metal sulfide:

Conversion rate=[PHA charged (mol)−PHA residual amount (mol)]/[PHA charged (mol)−PHA excess amount (mol)].

(b) In cases other than (a) above:

Conversion rate=[PHA charged (mole)−PHA residual amount (mole)]/[PHA charged (mole)].

### Recovery Process

In the method for producing the (A) PPS resin used in the present invention, a solid material is recovered from a polymerization reaction product containing a polymer, a solvent and the like after the completion of polymerization. Any known recovery method may be adopted for the PPS resin used in the present invention.

For example, after completion of the polymerization reaction, a method of slowly cooling and recovering the particulate polymer may be used. The slow cooling rate at this time is not particularly limited, but is usually about 0.1° C./min to 3° C./min. There is no need for slow cooling to be at the same rate in the whole process of the slow cooling step, and a method of slow cooling at a rate of 0.1 to 1° C./min until the polymer particles crystallize and then at a rate of 1° C./min or more, may be adopted. When the above recovery method is used, a PPS resin in which the above-described chloroform extraction amount is in a preferable range can be obtained.

Moreover, it is also one of the preferable methods to perform said recovery under quenching conditions. A Flash method is one of the preferable methods of this recovery method. The Flash method is a method in which a polymerization reaction product is flashed from a high-temperature and high-pressure state (normally 250° C. or higher, 8 kg/cm' or higher) into an atmosphere of normal pressure or reduced pressure, and the polymer is recovered in powder form simultaneously with solvent recovery. In this case, the flash means that the polymerization reaction product is ejected from a nozzle. Specific examples of the atmosphere to be flashed include nitrogen or water vapor at normal pressure, and the temperature is usually selected from the range of 150° C. to 250° C.

Among them, in order to develop a more excellent low oligomer property, a method of slowly cooling after the completion of the polymerization reaction and recovering the particulate polymer is preferably used in order to increase the cleaning effect with the organic solvent described later.

### Post-Processing Process

The (A) PPS resin used in the present invention may be produced through the above polymerization and recovery steps and then subjected to acid treatment, hot water treatment or washing with an organic solvent.

When acid treatment is performed, it is as follows. The acid used for the acid treatment of the PPS resin in the present invention is not particularly limited as long as it does not have an action of decomposing the PPS resin, and examples thereof include acetic acid, hydrochloric acid, sulfuric acid, phosphoric acid, silicic acid, carbonic acid, and propyl acid. Of these, acetic acid and hydrochloric acid are more preferably used, but those that decompose and deteriorate the PPS resin such as nitric acid are not preferable.

As the acid treatment method, there is a method of immersing the PPS resin in an acid or an acidic aqueous solution, and it is possible to appropriately stir or heat as necessary. For example, when acetic acid is used, a sufficient effect can be obtained by immersing the PPS resin powder in an aqueous pH 4 solution heated to between 80 and 200° C. and stirring for 30 minutes. The pH after the treatment may be 4 or more, for example, about pH 4-8. The acid-treated PPS resin is preferably washed several times with water or warm water in order to remove residual acid or salt. The water used for washing is preferably distilled water or deionized water in the sense that the effect of the preferred chemical modification of the PPS resin by acid treatment is not impaired.

When performing hot water treatment, it is as follows. In the hot water treatment of the PPS resin used in the present invention, the temperature of the hot water is preferably 100° C. or higher, more preferably 120° C. or higher, further preferably 150° C. or higher, and particularly preferably 170° C. or higher. Less than 100° C. is not preferable because the effect of preferable chemical modification of the PPS resin is small.

The water used is preferably distilled water or deionized water in order to express the preferable chemical modification effect of the PPS resin by the hot water washing according to the present invention. There is no particular limitation on the operation of the hot water treatment, and a predetermined amount of PPS resin is put into a predetermined amount of water and heated and stirred in a pressure vessel, or a continuous hot water treatment is performed. The ratio of water is preferably higher than that of the PPS resin, but usually a bath ratio of 200 g or less of PPS resin is selected for 1 liter of water.

Further, since the decomposition of the terminal group is not preferable, the treatment atmosphere is preferably an inert atmosphere in order to avoid decomposition of the terminal group. Further, the PPS resin after the hot water treatment operation is preferably washed several times with warm water in order to remove remaining components.

The organic solvent used for washing the PPS resin in the present invention is not particularly limited as long as it does not have a function of decomposing the PPS resin. For example, polar solvents containing nitrogen such as N-methyl-2-pyrrolidone, dimethylformamide, dimethylacetamide, 1,3 -dimethylimidazolidinone, hexamethylphosphoramide, and piperazinones; sulfoxide-sulfone series solvents such as dimethyl sulfoxide, dimethyl sulfone, and sulfolane;

ketone series solvents such as acetone, methyl ethyl ketone, diethyl ketone, and acetophenone; ether series solvents such as dimethyl ether, dipropyl ether, dioxane, and tetrahydrofuran; halogen series solvents such as chloroform, methylene chloride, trichloroethylene, ethylene dichloride, perchlorethylene, monochloroethane, dichloroethane, tetrachloroethane, perchlorethane, and chlorobenzene; and aromatic hydrocarbon series solvents such as benzene, toluene and xylene, can be used.

Among these organic solvents, the use of NMP, acetone, dimethylformamide, chloroform and the like is preferable, and the use of N-methyl-2-pyrrolidone is particularly preferable in terms of obtaining an excellent oligomer removal effect. These organic solvents are used alone or in combination of two or more.

As a method of washing with an organic solvent, there is a method of immersing a PPS resin in an organic solvent, and if necessary, stirring or heating can be appropriately performed. There is no particular limitation on the washing temperature when washing the PPS resin with organic solvents, and any temperature from room temperature to about 300° C. can be selected. The higher the washing temperature, the higher the washing efficiency tends to be. However, a sufficient effect is usually obtained at a washing temperature of room temperature to 150° C. It is also possible to wash under pressure in a pressure vessel at a temperature above the boiling point of the organic solvent.

There is no particular limitation on the washing time. Depending on the washing conditions, in the case of batch-type washing, a sufficient effect can be obtained usually by washing for 5 minutes or more. It is also possible to wash in a continuous manner. Such washing with organic solvents is a process suitable for the production of the (A) PPS resin used in the present invention because a high oligomer removal effect is obtained.

In the present invention, the polyphenylene sulfide resin obtained as described above may be treated by washing with water containing an alkaline earth metal salt. The following method can be illustrated as a specific method when the polyphenylene sulfide resin is washed with water containing an alkaline earth metal salt. There are no particular limitations on the type of alkaline earth metal salt, but alkaline earth metal salts of water-soluble organic carboxylic acids such as calcium acetate and magnesium acetate are preferable examples, and alkaline earth metal salts of water-soluble organic carboxylic acids such as calcium acetate and magnesium acetate are particularly preferable.

The temperature of water is preferably room temperature to 200° C., more preferably 50 to 90° C. The amount of the alkaline earth metal salt used in the water is preferably 0.1 to 50 g, more preferably 0.5 to 30 g, for 1 kg of the dried polyphenylene sulfide resin. The washing time is preferably 0.5 hours or longer, and more preferably 1.0 hour or longer. The preferred washing bath ratio (weight of warm water containing alkaline earth metal salt per unit weight of dry polyphenylene sulfide resin) depends on the washing time and temperature, but it is preferable to wash using preferably 5 kg or more, or more preferably 10 kg or more of warm water containing alkaline earth metal per 1 kg of dry polyphenylene sulfide.

There is no limitation in particular as an upper limit and it can be high as to the amount of warm water containing alkaline earth metal, it is preferable that it is 100 kg or less from the point of the usage-amount and the effect acquired. Such warm water washing may be performed a plurality of times.

The (A) PPS resin used in the present invention can also be used after having been polymerized by heating in an oxygen atmosphere and a thermal oxidation crosslinking treatment by heating with addition of a crosslinking agent such as peroxide.

In the case of dry heat treatment for the purpose of increasing the molecular weight by thermal oxidation crosslinking, the temperature is preferably in the range of 160 to 260° C., more preferably 170 to 250° C. The oxygen concentration during treatment is preferably 5% by volume or more, more preferably 8% by volume or more.

Although there is no limitation in particular in the upper limit of oxygen concentration, about 50 volume% may be a limit. The treatment time is preferably 0.5 to 100 hours, more preferably 1 to 50 hours, and further preferably 2 to 25 hours. The heat treatment apparatus may be a normal hot air drier or a heating apparatus with a rotary or stirring blade. But in order to process efficiently and more uniformly, it is more preferable to use a heating apparatus with a rotary type or a stirring blade.

However, from the viewpoint of achieving both low oligomer elution and excellent melt fluidity, the introduction of a cross-linked structure is less preferred, and a linear PPS is preferred.

Also, dry heat treatment can be performed for the purpose of suppressing thermal oxidative cross-linking and removing volatile matter. The temperature is preferably in the range of 130 to 250° C., more preferably 160 to 250° C. In this case, the oxygen concentration is preferably less than 5% by volume, and more preferably less than 2% by volume.

The treatment time is preferably 0.5 to 50 hours, more preferably 1 to 20 hours, and even more preferably 1 to 10 hours. The heat treatment apparatus may be a normal hot air drier or a heating apparatus with a rotary or stirring blade but in order to process efficiently and more uniformly, it is more preferable to use a heating apparatus with a rotary type or a stirring blade.

In the present invention, the use of a PPS resin in which the ash content of the PPS resin is reduced to 0.2% by weight or less by deionization treatment or the like is preferable in terms that the resin composition containing the PPS resin has better toughness and molding processability. Specific examples of such deionization treatment include acid aqueous solution washing treatment, hot water washing treatment, and organic solvent washing treatment, and these treatments may be used in combination of two or more methods.

In addition, the following methods are mentioned here for the measurement of the amount of ash. About 5 g of dry PPS bulk powder is weighed into a platinum crucible and baked until it becomes a black lump on an electric stove. Next, the firing is continued in the electric furnace set at 550° C. until the carbide is completely fired. Thereafter, after cooling in a desiccator, the weight is measured, and the ash content can be calculated from the comparison with the initial weight. The lower limit of the ash content of the PPS resin is ideally 0, but a PPS resin having an ash content of 0.1% by weight or more can be preferably used.

For example, by adopting the production method as described above, it is possible to obtain (A) PPS resin having excellent low oligomer dissolution property and melt fluidity, which can thus be used for the various applications mentioned herein.

Component (B): Glycidyl group-containing copolymer comprising α-olefin and α, β-unsaturated glycidyl ester as copolymerization components

The glycidyl group-containing copolymer comprising (B) an α-olefin and an α, β-unsaturated glycidyl ester as a copolymerization component according to the present invention includes a copolymer obtained from an α-olefin, and an α, β-unsaturated glycidyl ester, and when necessary, a copolymer by copolymerizing an unsaturated acid monomer which is copolymerizable with them. It is preferable to use 60% by weight or more of α-olefin and α, β-unsaturated glycidyl ester in the total copolymer components.

Examples of the α-olefin include ethylene, propylene, 1-butene, 1-pentene, 1-octene, and the like. Two or more of these may be used. Examples of the glycidyl ester of α, β-unsaturated acid include glycidyl acrylate, glycidyl methacrylate, glycidyl ethacrylate, and glycidyl itaconate. Two or more of these may be used. Glycidyl methacrylate is preferably used. Examples of unsaturated acid monomers copolymerizable with the above components include vinyl esters such as vinyl ethers, vinyl acetate, and vinyl propionate; acrylic acid and methacrylate esters such as methyl, ethyl, propyl, and butyl; acrylonitrile; and styrene. Two or more of these may be used.

Preferred examples of the glycidyl group-containing copolymer comprising (B) an α-olefin and a glycidyl ester of α, β-unsaturated acid in the present invention as a copolymerization component include ethylene/glycidyl methacrylate copolymer, ethylene/glycidyl methacrylate/vinyl acetate copolymer, ethylene/glycidyl methacrylate/acrylic ester copolymer, ethylene/glycidyl acrylate/vinyl acetate copolymer, and the like. Two or more of these may be used.

From the viewpoint of further improving the low-temperature welding strength of a molded product obtained from the resin composition, the glycidyl group-containing copolymer is preferably a binary copolymer containing glycidyl group comprising an α-olefin and a glycidyl ester of α, β-unsaturated acid as a copolymerization component. Specifically, an ethylene/glycidyl methacrylate copolymer is more preferable.

A particularly preferred ethylene/glycidyl methacrylate copolymer is available from Sumitomo Chemical Co., Ltd.© under the trade name Bond First E®

The mixing amount of the glycidyl group-containing copolymer comprising (B) an α-olefin and a glycidyl ester of α, β-unsaturated acid in the present invention as a copolymerization component is in the range of 5-15 parts by weight with respect to 100 parts by weight of (A) polyphenylene sulfide resin. If the mixing amount of the glycidyl group-containing copolymer containing (B) an α-olefin and a glycidyl ester of α, β-unsaturated acid as a copolymer component is less than 5 parts by weight with respect to 100 parts by weight of the (A) polyphenylene sulfide resin, the impact strength of the extruded product is lowered. Thus, 5 parts by weight or more is preferable, and 7 parts by weight or more is more preferable.

If the mixing amount of the glycidyl group-containing copolymer containing (B) an α-olefin and a glycidyl ester of α, β-unsaturated acid as a copolymer component is more than 15 parts by weight with respect to 100 parts by weight of the (A) polyphenylene sulfide resin, the amount of gas generated during process increases. Thus, 15 parts by weight or less is preferable, 13 parts by weight or less is more preferably, and 11 parts by weight or less is even more preferably.

Component (C): An ethylene/α-olefin copolymer comprising ethylene and an α-olefin having 3 to 20 carbon atoms as a copolymerization component

The (C) ethylene/α-olefin copolymer comprising ethylene and an α-olefin having 3 to 20 carbon atoms according to the present invention is a copolymer of ethylene and an α-olefin having 3 to 20 carbon atoms polymerized. In addition to the ethylene and the α-olefin having 3 to 20 carbon atoms described above, other components can be added as long as the effects of the present invention are not adversely affected. In this case, a possible component includes a glycidyl ester of α, β-unsaturated unsaturated acid as the other components, and the components considered to be the (B) glycidyl group-containing copolymer having α-olefin and α, β-unsaturated acid glycidyl ester is a copolymerization component.

Examples of the α-olefin having 3 to 20 carbon atoms of the ethylene/α-olefin copolymer of (C) ethylene and an α-olefin having 3 to 20 carbon atoms as a copolymerization component, used in the present invention, include propylene, isobutylene, 1-butene, 1-pentene, 1-hexene, 4-methyl-1-pentene, 1-heptene, 1-octene, 1-nonene, 1-decene, and the like, and among these 1-butene and 1-octene are particularly preferred.

A particularly preferred ethylene/1-butene copolymer is available from Mitsui Chemicals, Inc.© under the trade name TAFMER A4085S®.

The mixing amount of the ethylene/α-olefin copolymer containing (C) ethylene and an α-olefin having 3 to 20 carbon atoms used in the present invention as a copolymerization component is in the range of 0-20 parts by weight with respect to 100 parts by weight of the (A) polyphenylene sulfide resin. If the mixing amount of the ethylene/α-olefin copolymer containing (C) ethylene and an α-olefin having 3 to 20 carbon atoms as a copolymerization component exceeds 20 parts by weight, the amount of gas generated during processing increases. Thus, 20 parts by weight or 18 parts by weight or less is more preferable, and 15 parts by weight or less is even more preferable.

Component (D): Glass fiber

Although there is no limitation about the cross-sectional shape of (D) the glass fiber used for this invention, for example, the cross-sectional shape of round shape, flat shape, eyebrows shape, oval shape, elliptical shape, semicircle, or circular arc shape, a rectangle, or these similar shapes can be used.

The fiber diameter of the (D) glass fiber having a round cross-sectional shape according to the present invention (hereinafter sometimes abbreviated as a round glass fiber) is preferably 4 μm to more preferably 6 μm to 20 μm.

In the present invention, the (D) glass fiber is preferably opened in the polyphenylene sulfide resin composition. Here, the opened state means a state in which the (D) glass fiber in the polyphenylene sulfide resin composition is opened to a single fiber. Specifically, it means the state in which the number of reinforcing fibers in a bundle of 10 or more is 40% or less of the total number of reinforcing fibers when observed.

The (D) glass fiber used in the present invention is preferably treated with a sizing agent or a surface treatment agent. Examples of the sizing agent or surface treatment agent include functional compounds such as epoxy compounds, isocyanate compounds, silane compounds, and titanate compounds. Epoxy compounds having a high epoxy content are particularly preferred from the viewpoint of improving the heat and moisture resistance of the reinforcing fibers.

The (D) glass fiber of the present invention having a round cross-sectional shape can be obtained, for example, from Nippon Electric Glass Co., Ltd.© under the trade name T-760H.

The mixing amount of the (D) glass fiber used in the present invention is in the range of 10 to 50 parts by weight with respect to 100 parts by weight of the (A) polyphenylene sulfide resin. If the mixing amount of the (D) glass fiber is less than 10 parts by weight, the strength of an extrusion molded product will fall. Thus, 10 parts by weight or more is preferable, 13 parts by weight or more is more preferable and 15 parts by weight or more is even more preferable. If the mixing amount of the (D) glass fiber is more than 50 parts by weight, the amount of gas generated during process increases. Thus, 50 parts by weight or less is preferable, 30 parts by weight or less is more preferable, and 20 parts by weight or less is even more preferable.

Component (E): High density polyethylene

The high-density (E) polyethylene used in the present invention preferably has a melt flow rate measured at 190° C. and 2.16 kg of 0.01 to 0.1 g / 10 min. The high-density (E) polyethylene of the present invention can be obtained from Prime Polymer Co., Ltd.© under the trade name HI-ZEX 7000FP.

The mixing amount of high-density (E) polyethylene used in the present invention is in the range of 1.5 to 4 parts by weight with respect to 100 parts by weight of the (A) polyphenylene sulfide resin. If the mixing amount of high-density (E) polyethylene is less than 1.5 parts by weight, the extrusion processability is lowered. Thus, the amount is preferably 1.5 parts by weight or more and 1.7 parts by weight is more preferable. If the mixing amount of high-density (E) polyethylene is more than 4 parts by weight, the amount of gas generated during process increases. Thus, the amount is preferably 4 parts by weight or less, 3 parts by weight or less is more preferable and 2.5 parts by weight or less is even more preferable.

In the polyphenylene sulfide resin composition in the present invention, other components can be added within the range not impairing the effects of the present invention. Other components include: heat stabilizer agents (hindered phenol series, hydroquinone series, phosphite series and substituted products thereof), weathering agents (resorcinol series, salicylate series, benzotriazole series, benzophenone series, hindered amine series, etc.), release agents and lubricants (montanic acid and its metal salts, its esters, its half esters, stearyl alcohol, stearamide, various bisamides, and bisureas etc.), pigments (cadmium sulfide, phthalocyanine, carbon black for coloring, etc.), dyes (nigrosine, etc.), plasticizers (octyl p-oxybenzoate, N-butylbenzenesulfonamide, etc.), antistatic agents (alkyl sulfate anions antistatic agent, grade 4 ammonium salt type cationic antistatic agent, nonionic antistatic agents such as polyoxyethylene sorbitan monostearate, and betaine amphoteric antistatic agent, etc.), flame retardants (for example, red phosphorus, phosphate ester, melamine cyanurate, hydroxides such as magnesium hydroxide and aluminum hydroxide, ammonium polyphosphate, brominated polystyrene, brominated polyphenylene ether, brominated polycarbonate, brominated epoxy resins or combinations of these brominated flame retardants with antimony trioxide), and other polymers (for example, amorphous resins such as polyamideimide, polyarylate, polyethersulfone, polysulfone, polyphenylene ether, etc.)

In the polyphenylene sulfide resin composition of the present invention, it is preferable that the components (A) to (E) and other components mixed as necessary are uniformly dispersed. As a method for producing the polyphenylene sulfide resin composition of the present invention, for example, a method of melt kneading each component using a known melt kneader such as a single or twin screw extruder, a Banbury mixer, a kneader, or a mixing roll, can be used. Each component may be mixed in advance and then melt kneaded.

In addition, as a method of charging each component into the melt-kneader, for example, using a single-screw or twin-screw extruder, the above (A), (B), (D) and (E) components are supplied from the main charging port installed on the screw base side, (C) glass fiber is supplied from a sub input port installed between the main input port and the tip of the extruder, and melt-mixed.

The melt kneading temperature is preferably 220° C. or higher, and more preferably 280° C. or higher, in terms of excellent fluidity and mechanical properties. Moreover, 400° C. or less is preferable and 360° C. or less is more preferable. Here, the melt kneading temperature refers to the set temperature of the melt kneader, and refers to the cylinder temperature in the case of a twin screw extruder, for example.

The PPS resin composition obtained in this manner is suitable for extrusion molding applications, and is suitable for extrusion molding products having an average outer diameter of 50 mm or more by virtue of processability during extrusion and the small amount of generated gas.

The PPS resin composition used in the present invention is excellent in processability at the time of extrusion molding, and moreover with less generated gas, therefore extruded product having a good appearance can be obtained, which is useful for electronic equipment, automobile parts, structural parts, machine parts, oil drilling and transport parts, etc. It is used for, as structural parts, pipe parts such as joints and pipes, as automotive parts, various fuel-related, exhaust, intake-type pipe parts, and as oil drilling/transport parts, tubes for transportation and excavation, etc.

### EXAMPLES

Hereinafter, the present invention will be described more specifically with reference to embodiments. However, the present invention is not limited to the description of these embodiments.

### Measuring Method

(1) Amount of chloroform extracted from PPS resin Using a Soxhlet extractor, extract about 10 g of a PPS sample and 200 ml of chloroform for 5 hours, dry the extract at 50° C., and obtain the residue. Calculate resulting residue divided by the amount of PPS sample charged, and multiply by 100 to express the extracted amount in a percentage.

(2) PPS resin melt flow rate (MFR)

The measurement temperature was 315.5° C. with 5000 g load, and the measurement was performed by a method according to ASTM-D1238-70.

(3) Feeding stability

Using an injection molding machine made by JSW (product name: J85-AD-110H), the measurement time when measuring 60 mm of a sample at a cylinder temperature of 320° C. and a screw rotation speed of 20 rpm, was used as an index of the feeding stability.

(4) Tensile strength

Measurement was performed in accordance with IS0527-1, 2.

(5) Impact strength (notched impact test)

Measured according to ISO179-1.

(6) Heat loss

10 g of pellets dried for 3 hours in an oven at 150° C. were heated in an oven at 330° C. for 3 hours, and the weight loss rate before and after heating was measured.

### Raw Materials Used

### <Reference Example 1>Polymerization of PPS (A1)

In a 70 liter autoclave equipped with a stirrer, 8267.37 g (70.00 mol) of 47.5% sodium hydrosulfide, 2957.21 g (70.97 mol) of 96% sodium hydroxide, 11434.50 g (115.50 mol) of N-methyl-2-pyrrolidone (NMP), 2583.00 g (31.50 mol) of sodium acetate, and 10500 g of ion-exchanged water, are charged and gradually heated to 245° C. over about 3 hours under nitrogen at normal pressure. After distilling out 14780.1 g of water and 280 g of NMP, the reaction vessel was cooled to 160° C. The residual water content in the system per 1 mol of the charged alkali metal sulfide was 1.06 mol including the water consumed for the hydrolysis of NMP. The amount of hydrogen sulfide scattered was 0.02 mol per 1 mol of the alkali metal sulfide charged.

Next, 10235.46 g (69.63 mol) of p-dichlorobenzene and 9009.00 g (91.00 mol) of NMP were added, the reaction vessel was sealed under nitrogen gas, and the mixture was heated to 238° C. at a rate of 0.6 ° C./min. while stirring at 240 rpm. After reacting at 238° C. for 95 minutes, the temperature was raised to 270° C. at a rate of 0.8° C./min. Then, after performing the reaction at 270° C. for 100 minutes, 1260 g (70 mol) of water was injected over 15 minutes and cooled to 250 ° C. at a rate of 1.3° C./min. Then, after cooling to 200° C. at a rate of 1.0° C./min., it was rapidly cooled to near room temperature.

The contents were taken out, diluted with 26300 g of NMP, the solvent and solid material were filtered off with a sieve (80 mesh), and the obtained particles were washed with 31900 g of NMP and filtered off. This was washed several times with 56000 g of ion-exchanged water and filtered, then washed with 70000 g of 0.05 wt. % aqueous acetic acid and filtered. After washing with 70000 g of ion-exchanged water and filtering, the obtained hydrous PPS particles were dried with hot air at 80° C. and dried under reduced pressure at 120° C. The obtained PPS was MFR 100 g/10 min.

### <Reference Example 2>Polymerization of PPS (A2)

In a 70 liter autoclave equipped with a stirrer and a bottom plug valve, 8.27 kg (70.00 mol) of 47.5% sodium hydrosulfide, 2.94 kg (70.63 mol) of 96% sodium hydroxide, 11.45 kg (115.50 mol) of N-methyl-2-pyrrolidone (NMP), 1.89 kg (23.1 mol) of sodium acetate, and 5.50 kg of ion-exchanged water, are charged and gradually heated to 245° C. over about 3 hours under nitrogen at normal pressure. After distilling out 9.77 kg of water and 0.28 kg of NMP, the reaction vessel was cooled to 200° C. The residual water content in the system per 1 mol of the charged alkali metal sulfide was 1.06 mol including the water consumed for the hydrolysis of NMP. The amount of hydrogen sulfide scattered was 0.02 mol per 1 mol of the charged alkali metal sulfide.

Thereafter, the mixture was cooled to 200° C., 10.42 kg (70.86 mol) of p-dichlorobenzene and 9.37 kg (94.50 mol) of NMP were added, the reaction vessel was sealed under nitrogen gas, heated from 200° C. to 270° C. at a rate of 6° C./min., and then reacted at 270° C. for 140 minutes. Thereafter, 2.40 kg (133 mol) of water was injected while cooling from 270° C. to 250° C. over 15 min. Next, the mixture was gradually cooled from 250° C. to 220° C. over 75 minutes, and then rapidly cooled to near room temperature, and the contents were taken out.

The contents were diluted with about 35 liters of NMP, stirred as a slurry at 85° C. for 30 minutes, and then filtered through an 80 mesh wire mesh (aperture 0.175 mm) to obtain a solid material. The obtained solid material was similarly washed and filtered with about 35 liters of NMP. The operation of diluting the obtained solid material with 70 liters of ion-exchanged water, stirring at 70° C. for 30 minutes, and filtering through an 80 mesh wire net to recover the solid material, was repeated a total of 3 times.

The obtained solid material and 32 g of acetic acid were diluted with 70 liters of ion exchange water, stirred at 70° C. for 30 minutes, then filtered through an 80 mesh wire net, and further obtained solid material was diluted with 70 liters of ion exchange water, stirred at 70° C. for 30 minutes, and then filtered through an 80 mesh wire net to recover a solid material. The solid material thus obtained was dried at 120° C. under a nitrogen stream to obtain dry PPS.

The obtained PPS had melt flow rate (MFR) of 300 g /10 min.

### Examples 1 to 10

As shown in Table 1, the composition of the resin composition was changed. The components (A), (B), (C), and (E) were supplied from the main charging port of the twin-screw extruder, the component (D) was supplied from the sub input port installed between the main input port and the tip of the extruder, the mixture was melt-kneaded with a twin-screw extruder having a screw diameter of 26 mm at a cylinder temperature set at 300° C. Then the mixture was pelletized by a strand cutter. Molding and evaluation were performed using pellets dried overnight at 120° C.

TABLE 1

| | | | | Example | | | | | | | | | |
|---|---|---|---|---|---|---|---|---|---|---|---|---|---|
| | | | | 1 | 2 | 3 | 4 | 5 | 6 | 7 | 8 | 9 | 10 |
| Resin | (A) polyphenylene | A1 | parts by | 35 | 59 | 75 | 100 | 0 | 59 | 59 | 59 | 59 | 59 |
| Composition | sulfide resin | | weight | | | | | | | | | | |
| | | A2 | parts by | 65 | 41 | 35 | 0 | 100 | 41 | 41 | 41 | 41 | 41 |
| | | | weight | | | | | | | | | | |
| | (B) Ethylene/glcidyl | B1 | parts by | 9.5 | 9.5 | 9.5 | 9.5 | 9.5 | 11 | 7 | 13 | 9.5 | 9.5 |
| | methacrylate | | weight | | | | | | | | | | |
| | (C) Ethylene/α-olefin | C1 | parts by | 12.5 | 12.5 | 12.5 | 12.5 | 12.5 | 0 | 18 | 12.5 | 12.5 | 12.5 |
| | copolymer | | weight | | | | | | | | | | |
| | (D) Glass fiber | D1 | parts by | 18.5 | 18.5 | 18.5 | 18.5 | 18.5 | 18.5 | 18.5 | 18.5 | 40 | 18.5 |
| | | | weight | | | | | | | | | | |
| | (E) Polyethylene | E1 | parts by | 2 | 2 | 2 | 2 | 2 | 2 | 2 | 2 | 2 | 3.5 |
| | | | weight | | | | | | | | | | |

| | | | | | | | | | | | | |
|---|---|---|---|---|---|---|---|---|---|---|---|---|
| Biting Stability | — | seconds | 45 | 46 | 46 | 50 | 51 | 42 | 45 | 48 | 48 | 45 |
| Tensile Strength | ISO 527-1.2 | MPa | 95 | 93 | 93 | 92 | 96 | 105 | 85 | 80 | 155 | 95 |
| Impact Strength | ISO 179-1 | MPa | 22 | 22 | 23 | 24 | 20 | 17 | 22 | 28 | 25 | 22 |
| Loss on Heating | — | % | 1.4 | 1.5 | 1.6 | 2.3 | 1.1 | 1.1 | 1.6 | 2.5 | 1.7 | 1.8 |

(B): Ethylene/glycidyl methacrylate/methyl acrylate copolymer (Sumitomo Chemical Co., Ltd. © under the trade name Bond First E)
(C): Ethylene/α-olefin copolymer (TAFMER A4085S ® by Mitsui Chemicals, Inc. ©)
(D): Glass fiber (T-760H (trade name) by Nippon Electric Glass Co., Ltd. ©, 3 mm long, average fiber diameter: 10.5 μm)
(E): High density polyethylene (Prime Polymer Co., Ltd.: HI-ZEX 7000FP)

### Comparative Examples 1 to 5

As shown in Table 2, the composition of the resin composition was changed. The components (A), (B), (C), and (E) were supplied from the main charging port of the twin-screw extruder, the component (D) was supplied from the sub input port installed between the main input port and the tip of the extruder, the mixture was melt-kneaded with a twin-screw extruder having a screw diameter of 26 mm at a cylinder temperature set at 300° C. Then the mixture was pelletized by a strand cutter. Molding and evaluation were performed using pellets dried overnight at 120° C. In any case, any of the feeding stability, tensile strength, impact strength, and loss on heating was inferior.

TABLE 2

| | | | | Comparative Examples | | | | | |
|---|---|---|---|---|---|---|---|---|---|
| | | | | 1 | 2 | 3 | 4 | 5 | 7 |
| Resin | (A) polyphenylene | A1 | parts by | 59 | 59 | 59 | 59 | 59 | 59 |
| Composition | sulfide resin | | weight | | | | | | |
| | | A2 | parts by | 41 | 41 | 41 | 41 | 41 | 41 |
| | | | weight | | | | | | |
| | (B) Ethylene/glycidyl | B1 | parts by | 0 | 9.5 | 9.5 | 9.5 | 9.5 | 20 |
| | methacrylate | | weight | | | | | | |
| | (C) Ethylene/α-olefin | C1 | parts by | 0 | 12.5 | 12.5 | 12.5 | 12.5 | 25 |
| | copolymer | | weight | | | | | | |
| | (D) Glass fiber | D1 | parts by | 18.5 | 0 | 70 | 18.5 | 18.5 | 18.5 |
| | | | weight | | | | | | |
| | (E) Polyethylene | E1 | parts by | 2 | 2 | 2 | 0 | 6 | 2 |
| | | | weight | | | | | | |

| | | | | | | | | |
|---|---|---|---|---|---|---|---|---|
| Feeding Stability | — | seconds | 48 | 53 | 53 | 58 | 40 | 48 |
| Tensile Strength | ISO 527-1.2 | MPa | 110 | 55 | 220 | 95 | 92 | 72 |
| Impact Strength | ISO 179-1 | MPa | 8 | 30 | 15 | 22 | 20 | 31 |
| Loss on Heating | — | % | 1.1 | 1.6 | 2.5 | 1.1 | 2.9 | 3.3 |

### INDUSTRIAL APPLICABILITY

By utilizing the present invention, the extrudability of the polyphenylene sulfide resin composition can be greatly improved, and extruded products having various shapes and sizes such as tubes, pipes, and irregular shapes can be produced. In addition, productivity and process windows can be expanded accordingly.

What is claimed is:

1. A polyphenylene sulfide resin composition for extrusion molding comprising:
(A) a polyphenylene sulfide resin having a melt flow rate of from 50 g/10 min to 400 g/ 10 min measured at 316° C. and 5 kg;
(B) a glycidyl group-containing copolymer comprising α-olefin and α, β-unsaturated glycidyl ester as a copolymerization component;
(C) a copolymerization component comprising ethylene and an α-olefin having 3 to 20 carbon atoms;
(D) glass fiber; and
(E) polyethylene,
wherein:
the (A) polyphenylene sulfide resin is at least 100 parts by weight for every 5 to 15 parts by weight of the (B) glycidyl group-containing copolymer, 0 to 20 parts by weight of the (C) copolymerization component, 10 to 50 parts by weight of the (D) glass fiber, and 1.5 to 4 parts by weight of the (E) polyethylene.

2. The polyphenylene sulfide resin composition for extrusion molding according to claim 1 wherein:
the (A) polyphenylene sulfide resin comprises (A-1) and (A-2), and a weight ratio of the (A-1) and the (A-2) is from 3:7 to 7:3,
wherein:
the (A-1) is a polyphenylene sulfide resin having a melt flow rate measured at 316° C. and 5 kg, being from 50 g/10 min to 200 g/10 min, and
the (A-2) is a polyphenylene sulfide resin having a melt flow rate measured at 316° C. and 5 kg, being from 200 g/10 min to 400 g/10 min.

3. The polyphenylene sulfide resin composition for extrusion molding according to claim 1 wherein:
the (E) polyethylene comprises a polyethylene having a melt flow rate measured at 190° C. and 2.16 kg, being from 0.01-0.1 g/10 min.

4. An extruded product comprising the polyphenylene sulfide resin composition for extrusion molding according to claim 1.

5. The extruded product comprising the polyphenylene sulfide resin composition for extrusion molding according to claim 4, wherein the extruded product has an average outer diameter of 50 mm or more.
